(19) United States
(12) Patent Application Publication
(10) Pub. No.: US 2003/0160609 A9
(43) Pub. Date: Aug. 28, 2003

(54) Method and facility for storing and indexing web browsing data

(75) Inventors: Erik Snowberg, Seattle, WA (US); Vladimir Schipunov, Seattle, WA (US); Mark Smucker, Seattle, WA (US); Michael Wolf, (US)

Correspondence Address: BENNET K. LANGLOTZ, BOX 759, GENOA, NV, 89411, US

(73) Assignee: Avenue A, Inc.

(21) Appl. No.: 09/931,992

(22) Filed: Aug. 16, 2001

(51) Int. Cl. G01V 3/00; G06F 12/00; G06F 17/30

(52) U.S. Cl. 324/300; 324/301

(57) ABSTRACT

A method and facility for handling data regarding web activity of a population of users includes recording a selected web activity by a user and determining a cookie associated with the web activity. A plurality of different storage devices are provided. Each storage device is assigned a unique range of cookie values. A data set associated with the selected web activity is stored in the storage device that has an assigned range into which the cookie falls. The data sets are indexed by cookie for retrieval.

### FIELD OF THE INVENTION

This invention relates to internet communication, and more particularly to commercial and advertising communication methods that employ detailed user activity information while preserving user privacy.

### BACKGROUND AND SUMMARY OF THE INVENTION

The Internet is an effective tool for commercial communication. Companies use electronic communications with consumers to cost-effectively promote their goods or services. Normally, an Advertising Service Company (ASC) contracts with web publishers having advertising space, and with advertisers. Advertisements for the advertisers are placed on the publisher's sites, to be viewed by users while visiting those sites. Each time a user visits, a unique identifier (e.g. cookie) associated with the computer or other device employed by the user is collected by the advertising service company, and information about the visit is stored in the company's database. The collected information does not identify the user, yet is useful to correlate past activity associated with the uniquely identified and anonymous cookie. In addition, the ASC normally collects information about usage of the client's site, based on the different interactions by the multitudes of users. Detailed information may be transmitted by the client to the ASC by use of “action tags,” which are elements on the client's web page that trigger a communication with the ASC. That communication may have any needed information about the interaction appended for later use by the ASC.

In the course of operations, the ASC collects an immense amount of data, with many different browsing activity data sets collected for each of a multitude of cookies. As time progresses, this accumulated data grows in size, and requires extensive and expanding storage facilities. To make the stored data useful a large database facility is required, so that the data can be searched and sorted for commercial purposes. For instance, a commercial client of the ASC (such as web retailer that engages the ASC to place advertisements on other web sites) may wish to learn which cookies are best suited to receive future advertisements, based on whether those cookies have visited or purchased at the advertiser's site. The database is filled with data records for each visit, with each record including (for instance) the user cookie, the page visited, and other user activity information. To glean useful information, the entire database must be searched, and the records sorted. When the database is small enough to be contained in a single facility operated by a single processor, this is a simple and economic task.

However, with the large and growing size of the database, the records may be distributed among many storage devices, making retrieval of information much more complex. While feasible, extraordinary levels of computing power are required to make such an immense database usefully accessible. For the routine functions associated with normal database management software, processing capability may require extremely powerful processing power such as found only in supercomputers or other massive parallel processing facilities. While expensive, these are effective for a given database size. However, even these approaches are difficult to scale up to handle increasingly large database sizes. As a result, systems must be re-engineered over time to handle the growing need, adding further to costs.

Consequently, while there may be a real commercial advantage to be gained by analyzing collected web browsing data, that advantage is small in absolute terms for each additional record to be examined. In many instances the cost of maintaining and using required databases makes it more expensive to store, retrieve, and analyze the data than is justified by the commercial benefits. This leaves useful commercial information unexploited.

The present invention overcomes the limitations of the prior art by providing a method and facility for handling data regarding web activity of a population of users. The method and facility operate by recording selected web activity by a user and the cookie associated with that user. A plurality of different storage devices are provided. Each storage device is assigned a unique range of cookie values. A data set associated with the selected web activity is stored in the storage device that has an assigned range into which the cookie falls. The data sets are indexed by cookie for retrieval.

### BRIEF DESCRIPTION OF THE DRAWINGS

FIG. 1 is a schematic block diagram showing the system and method of operation according to a preferred embodiment of the invention.

FIG. 2 is a schematic block diagram showing the system and method of operation according to an alternative embodiment of the invention.

### DETAILED DESCRIPTION OF A PREFERRED EMBODIMENT

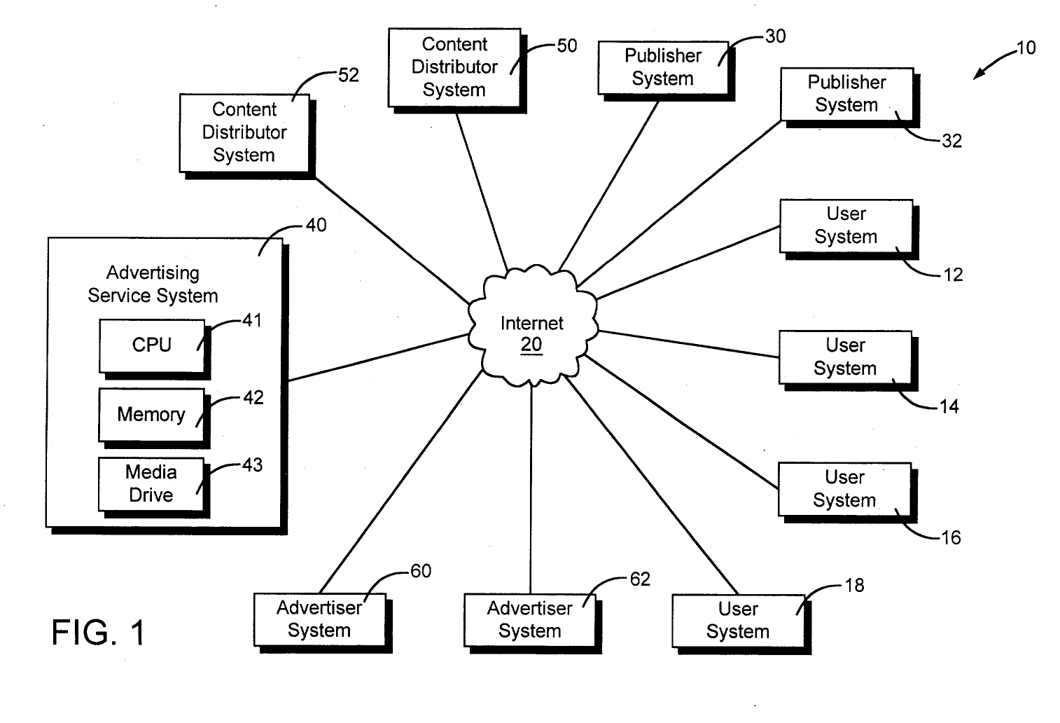

FIG. 1 is a high-level block diagram showing the environment and facility 10 in which the method preferably operates. The diagram shows a number of Internet customer or user computer systems 12, 14, 16, 18. An Internet customer preferably uses one such Internet customer computer system to connect, via the Internet 20, to an Internet publisher computer system, such as Internet publisher computer systems 30 and 32, to retrieve and display a Web page. Although discussed in terms of the Internet, this disclosure and the claims that follow use the term “Internet” to include not just personal computers, but all other electronic devices having the capability to interface with the Internet or other computer networks, including portable computers, telephones, televisions, appliances, electronic kiosks, and personal data assistants, whether connected by telephone, cable, optical means, or other wired or wireless modes including but not limited to cellular, satellite, and other long and short range modes for communication over long distances or within limited areas and facilities.

In cases where an Internet advertiser, through the Internet advertising service company, has purchased advertising space on the Web page provided to the Internet customer computer system by the Internet publisher computer system, the Web page contains a reference to a URL in the domain of the Internet Advertising Service Company (ASC) computer system 40. When a customer computer system receives a Web page that contains such a reference, the Internet customer computer systems sends a request to the Internet advertising service computer system to return data comprising an advertising message, such as a banner advertising message. When the Internet advertising service computer system receives such a request, it selects an advertising message to transmit to the Internet customer computer system in response the request. Then, it either transmits the selected advertising message itself, or redirects the request containing an identification of the selected advertising message to an Internet content distributor computer system, such as Internet content distributor computer systems 50 and 52. When the Internet customer computer system receives the selected advertising message, the Internet customer computer system displays it within the Web page. The Internet advertising service is not limited to banner advertisements, which are used as an example. Other Internet advertising modes include email messages directed to a user who has provided his or her email address in a request for such messages and “rich media” files which display multiple images in succession sometimes with significant capacity for interaction with the user.

The displayed advertising message preferably includes one or more links to Web pages of the Internet advertiser's Web site. When the Internet customer selects one of these links in the advertising message, the Internet customer computer system de-references the link to retrieve the Web page from the appropriate Internet advertiser computer system, such as Internet advertiser computer system 60 or 62. In visiting the Internet advertiser's Web site, the Internet customer may traverse several pages, and may take such actions as purchasing an item or bidding in an auction. While traversing these pages, requests are sent to the ASC indicating that the unique identifier associated with a user has accessed specific content on their client's site. The Internet advertising service computer system 40 preferably includes one or more central processing units (CPUs) 41 for executing computer programs such as the facility, a computer memory 42 for storing programs and data, and a computer-readable media drive 43, such as a CD-ROM drive, for reading programs and data stored on a computer-readable medium.

While preferred embodiments are described in terms of the environment described above, those skilled in the art will appreciate that the facility may be implemented in a variety of other environments, including a single, monolithic computer system, as well as various other combinations of computer systems or similar devices.

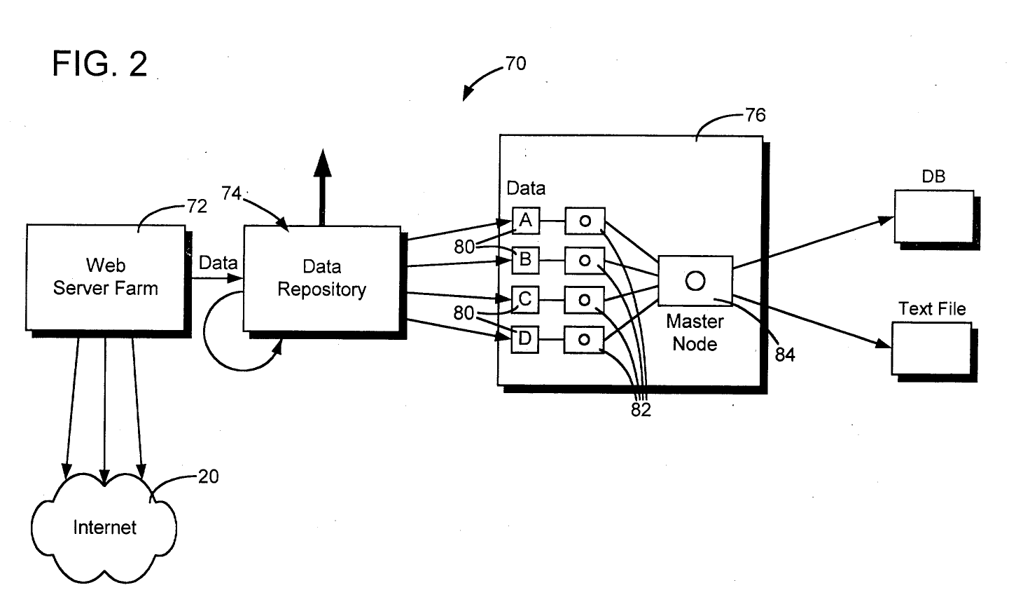

FIG. 2 shows a data collection and processing system 70 associated with the Advertising Service Company's system 40, and which may exist as part of the system, or which may exist independently. The processing system 70 connects to the internet 20 for collecting web browsing information from users visiting publisher sites at which the ASC is serving advertisements. To provide this, the ASC maintains a web server farm 72, which is a collection of web servers that are each connected to the internet for serving the requested information to the users.

In the course of serving advertisements to the users, the system also collects information from the users' computers (or other communication device). Typically, the user requests display of a web page, and this request generates a response by the ASC serving an advertisement on that page. Before the requested page is served to the user, the ASC queries the user device for its unique device identifier or cookie. Upon receipt of the cookie, and advertisement and requested page are served. In the process, the ASC receives information about the pages visited. This page visit information may include a wide range of information, including the specific page visited on the site, whether a purchase was made, the time and date of the visit, which products were purchased, what content was browsed and unique identifiers associated with the user or transaction by the ASC's client on the client's site.

This collected information is stored by the ASC as it is collected, in a data repository 74 connected to the servers of the server farm 72. The data repository serves as a buffer to hold the collected web browsing information until the information can be examined for routing to a storage device for long term storage. Long term storage need not be permanent, but is required to be long enough to collect adequate data to be usefully studied. In the preferred embodiment, the storage is essentially perpetual, but such data may be stored for analysis, and discarded after analysis. In such instances, a data result of the analysis may be stored in compact form, to preserve the valuable aspects of the data to be discarded. For instance, a user value score indicating a propensity to purchase or other desired attribute may be maintained and updated for each cookie, in the manner of a moving average, with newer data being weighted more heavily to give an ongoing current customer value score.

In any event, the user browsing data is transferred to a storage system 76 connected to the data repository. The storage system includes several storage devices 80 such as hard disk drives, each connected to its own associated processor 82. The processors and storage devices form pairs that each comprise a storage node that is independent of the others, without interconnections or coordinated operation. Each operates as a separate entity. However, the nodes are connected to the common input (the data repository) and to a common output, a master node 84. The master node includes a processor and storage facility so that it may retrieve selected data from any and all of the nodes, and process it to generate a useful output.

Unlike conventional storage systems in which all data is stored in a large, monolithic storage facility, to enable the entire data set to be sorted and processed for analysis, the data storage in the illustrated embodiment is constrained in a way that prevents such flexibility of searching, but which permits a much greater economy of storage and processing, while retaining the useful attributes desired for commercial web browsing data analysis, such as is used to plan and target internet advertisements to users. This is achieved by indexing the web browsing data by cookie on each storage node. Each node is assigned a set or range of cookie values. This need not be a sequence of contiguous cookie values, but may be any selected readily identifiable set of cookies, so that all possible cookies are covered by the set of nodes, and so that new nodes may be added to accommodate new cookies that become active in the future. In the preferred embodiment, cookies are assigned to nodes based on a modulo function that may be thought of as comparable to assigning cookie by the least significant digit, although this example would apply only when 10 servers were used, and the preferred modulo function would assign based on the reminder after dividing the cookie by a number based on the number of available nodes.

Over time, the number of nodes increases. In addition, if the amount of data stored per cookie generally increases, then occasional reshuffling of the data among the servers may be required. For instance, as a node reaches capacity for its assigned cookies, another node may be added to receive an offload of a portion of the first nodes range of cookies. Such added nodes may be segmented to accept overflow cookie ranges from several different nodes. Consequently, each node may not necessarily have a single range of cookie values after the system is implemented.

In the simplest exemplary case, nodes A, B, C and D are provided. Each is assigned a defined range or set of cookie values (A: 1, 5, 9, 13, etc., B: 2, 6, 10, 14, etc., C: 3, 7, 11, 15, etc.) In the preferred embodiment, each node contains a vastly larger number of cookies and their associated browsing history data. As more cookies are added, more nodes are added. The range assignment information is stored in the data repository 74, as well as in the master node 84. This enables the data repository processor to route each data element to the proper storage node, and enables the master node to retrieve data by cookie. The term “range” is used to indicate selected set, function, algorithm result, or criterion for assigning a cookie that definitely assigns any given cookie to a particular node each time.

The data on the local storage drives may be stored in a fairly unsorted manner. Data is broken up into files each of which contains only a small number of cookies much fewer than the capacity of the node, but that data is not sorted by cookie. The storage process requires that the machine read in a single file and sort it, and then process it. This makes it easier to add data to the file, since the data need not be put in a particular location within a file, but simply in the correct file.

Because the storage nodes are accessed independently for storage and retrieval, they do not need to be coordinated or act in concert. This allows the use of economical, conventional storage devices and processors, instead of the more complex and expensive systems associated with large databases. When an advertiser wishes to learn about the characteristics of those users who have visited or purchased at its site, it already has a list of cookies representing that group. The list may simply be provided to the master computer for retrieving the data records for each cookie, looking only in the node that is assigned a range encompassing the particular cookie. The retrieval process is facilitated by sorting the desired list of cookies into a sequence, and segmenting the sequence into ranges corresponding to the ranges for each node device. Each segment is then transmitted to the corresponding node for retrieval of the selected elements.

Upon retrieving the data for the selected cookies, the master node may preferably transmit the data for processing, or in an alternative embodiment, may process the data in any conventional manner to generate a useful text file or database. This may be further processed, or transmitted to other facilities for further processing to generate useful conclusions about the data, such as which subset of cookies are most suited to a certain advertising or other commercial treatment.

In the preferred embodiment, the nodes are provided by equipment such as small two processor servers. These are chosen because they can be obtained in models that only take up one unit of rack space. This allows many nodes to be packed into a small space. The master node is preferably a larger server that has 4 or 8 processors. The larger size of this node is not necessary for its use as a master node, but the master node is often used to divide up the cookie files and send them to the slave nodes.

Storage facilities are generally stored on local disk drives on the servers themselves, but could also be stored on a single larger storage entity such as a NAS Network Attached Storage drive when data volumes and the number of independent processors are small. In that case, the NAS drive becomes a limit to scalability. In a configuration with local storage scalability is basically infinite. A script with instructions is executed on the master node which will load any configuration parameters the script calls for. This information, along with the calculation instructions embodied in the script are sent to the slave nodes where they act on their own data stores in an independent fashion. When they have evaluated all their data they send the result set to the master node which may output the results into a database or text file.

The master and slave nodes can be connected by a very low bandwidth network as there is no information that needs to flow between the networks.

In contrast, the system required for a single integrated database capable of fully flexible searching of all data and all fields may require a much larger storage space to account for all of the logical indexing that needs to happen. Also, the nodes of a multi-machine database would need to be in constant communication requiring a much faster and “smarter” network to carry the necessary information between machines. Finally, a database would need many more servers for redundancy since the failure of a single machine will cause the entire operation of a query to be affected. With the system described herein, the failure of a single machine does not impact any of the other machines in the cluster.

While the above is discussed in terms of preferred and alternative embodiments, the invention is not intended to be so limited.

1. A facility for handling data regarding web activity of a plurality of users each having an associated cookie, comprising:
a plurality of storage devices;
each storage device containing web browsing activity information associated with the cookies of a selected subset of the users; and
all the web browsing information for each cookie being stored on a single storage device.

2. The facility of claim 1 including a data repository device connected to the storage devices, and operable to receive a stream of web browsing activity information from a plurality of web servers.

3. The facility of claim 2 wherein the data repository is operable to transmit a web browsing activity information and associated cookie to a selected one of the storage devices associated with the cookie.

4. The facility of claim 1 wherein each storage device is assigned a selected range of cookie values, and web browsing activity information associated with the selected range is stored in the associated storage device.

5. The facility of claim 1 wherein the storage devices are connected to a master computer operable to retrieve data from the storage devices.

6. The facility of claim 5 wherein the master computer is operable to analyze the data and generate an output.

7. The facility of claim 6 wherein the output includes a list of a subset of the cookies having a selected web browsing activity attribute.

8. The facility of claim 7 wherein the attribute is past activity at a selected web entity.

9. The facility of claim 1 wherein the web browsing activity information is indexed by cookie.

10. The facility of claim 1 wherein each of the storage devices includes a processor, and wherein the processors operate independently of each other.

11. A method of handling data regarding web activity of a plurality of users, comprising:
recording a selected web activity by a user;
determining a cookie associated with the web activity;
determining which of a selected plurality of storage devices contains information associated with the cookie; and
storing a data set associated with the selected web activity in the determined storage device.

12. The method of claim 11 including receiving a stream of web browsing activity information from a plurality of web servers, and transmitting the information to a selected one of the storage devices.

13. The method of claim 11 including establishing a selected range of cookie values for each storage device, and wherein determining which of a selected plurality of storage devices contains information associated with the cookie includes determining which selected range into which the cookie falls.

14. The method of claim 11 including providing a master computer operably connected to each of the storage devices, and operating the master computer to retrieve data from at least one of the storage devices.

15. The method of claim 14 including operating the master computer to analyze the data and generate an output.

16. The method of claim 15 wherein generating the output includes generating a list of a subset of the cookies having a selected web browsing activity attribute.

17. The method of claim 16 wherein the attribute is past activity at a selected web entity.

18. The method of claim 11 including indexing the web browsing activity information by cookie.

19. The method of claim 11 wherein each of the storage devices includes a processor, and including operating the processors independently of each other.

20. A method of handling data regarding web activity of a plurality of users, comprising:
recording a selected web activity by a user;
determining a cookie associated with the web activity;
providing a plurality of different storage devices;
assigning each storage device a unique set of cookie values; and
storing a data set associated with the selected web activity in the storage device having an assigned set into which the cookie falls.
